(19) United States
(12) Patent Application Publication
(10) Pub. No.: US 2002/0136382 A1
(43) Pub. Date: Sep. 26, 2002

(54) System and method for providing simplified conferencing

(76) Inventors: Alon Cohen, Tenafly, NJ (US); Tom Rust, Pennington, NJ (US); Nancy Denicola, East Hanover, NJ (US); Ran Sharon, Tenafly, NJ (US)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/101,940

(22) Filed: Mar. 21, 2002

Related U.S. Application Data
(60) Provisional application No. 60/277,656, filed on Mar. 22, 2001.

(51) Int. Cl. H04M 3/42

(52) U.S. Cl. 379/202.01

(57) ABSTRACT

A teleconference facilitation system and method may allow a user to pre-register a group or “team.” When the user contacts a server by, for example, a pre-arranged telephone number, the server attempts to initiate a teleconference among the user and the team members. The user may pre-schedule an automatically initiated conference call.

The present application clam the benefit of prior U.S. Provisional Patent application No. 60/277,656 filed on Mar. 22, 2001 and entitled “Telephone User Interface And Method For Providing One-Click Conferencing.”

### FIELD OF THE INVENTION

The present invention relates to teleconferencing; more specifically to a method and system for simplified teleconference initiation.

### BACKGROUND OF THE INVENTION

Teleconferencing involving multiple participants is commonplace. Telephone conference calling systems, including video conferencing systems, exist. Currently, setting up a teleconference requires, at minimum, a series of steps to be performed on the part of the conference initiator or initiators. For example, each participant may telephone a pre-arranged telephone number, possibly connecting to a server, with a pre-arranged code. In addition, one or more participants may initiate telephone calls to other participants who are joined to one teleconference using conference capabilities included with the telephone equipment or telephone exchange. These various methods take time, effort, and organization—e.g., telephone numbers and/or codes need to be stored or memorized, organized and located, and multiple series of steps may be required.

What is needed is a telephone conferencing system that allows a very simple step or series of steps to initiate a teleconference.

### SUMMARY OF THE INVENTION

In one embodiment of the present invention, a system and method are provided for facilitating a teleconference. A user may pre-register a group or a “team.” When the user contacts a server via, for example, a pre-arranged telephone number, a central server attempts to initiate a teleconference among the user and the team members. In a further embodiment, a user may pre-schedule an automatically initiated conference call.

### BRIEF DESCRIPTION OF THE DRAWINGS

The present invention will be understood and appreciated more fully from the following detailed description taken in conjunction with the drawings in which:

FIG. 1 shows a schematic diagram of a teleconference system and additional communications systems according to one embodiment of the present invention;

FIG. 2 is a flow chart depicting a method for conducting a conference call according to an embodiment of the present invention; and

FIG. 3 is a flow chart depicting a method for initiating a conference call according to an embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

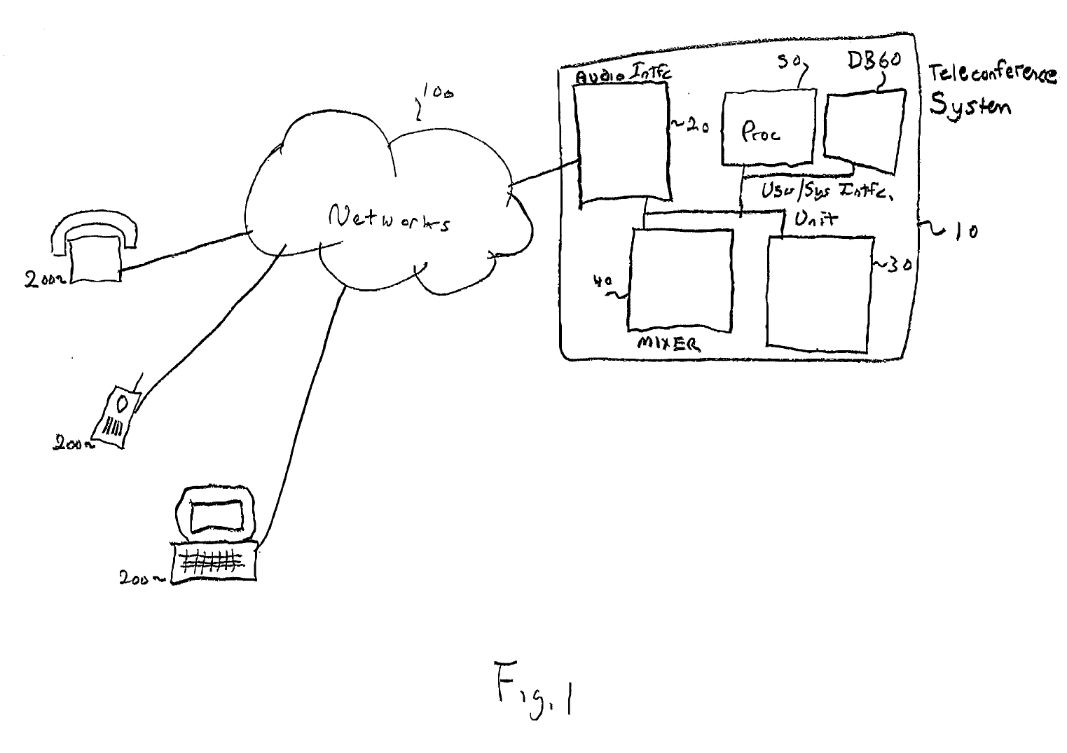

Reference is made to FIG. 1, which shows a schematic diagram of a teleconference system and additional communications systems according to one embodiment of the present invention. In an exemplary embodiment, the teleconference system 10 comprises an audio interface unit 20 for interfacing with audio data lines or other data carriers carrying audio information such as conversations, a user/system interface unit 30 interfacing with, e.g., a user interface or other equipment, and allowing control and data information to be output to and from teleconference system 10, a mixer unit 40, mixing audio channels and possibly performing other audio processing functionality, a processor 50, controlling the overall operation of teleconference system 10, and a database 60, storing, for example, user information, scheduling information, and/or other information. The database 60 may be implemented in known manners and may be combined with or physically distinct from the teleconference system 10. In alternate embodiments, additional components may be included, such as busses, interfaces, etc. In alternate embodiments, the teleconference system 10 may include, for example, known video conferencing, speech recognition capabilities, text to speech capabilities, DTMF detection, recording and/or play back capabilities, voice over IP (VoIP) interfaces, user authentication, and/or account maintenance functions such as accounting and billing systems.

Audio interface unit 20 is typically connected to one or more telecommunications networks 100. Telecommunications networks 100 may include, for example, a PSTN, PBX, cellular system, a wide area network, an intranet, the Internet, or other networks. Telecommunications networks 100 may connect to other networks (not shown) and to a series of communications devices 200, through known methods. Communications devices 200 may be, for example, conventional telephones, cellular devices (e.g., cellular telephones or PDAs), PCs, workstations or other computing devices with telephony capability, videoconference terminals, or other devices. Communications devices 200 may connect to each other and to teleconference system 10 to, for example, conduct audio telephony sessions such as telephone calls, via telecommunications networks 100.

Audio interface unit 20 typically operates through known methods to accept and output audio streams via, for example, conventional telephone lines, and may include typical functionality such as accepting multiple telephone calls and initiating multiple telephone calls. Audio interface unit 20 typically is able to determine the telephone number of the communications device placing a call to audio interface unit 20—e.g., through conventional caller identification methods. Audio interface unit 20 may include the capability to determine which of several possible telephone numbers assigned to audio interface unit 20 was used to contact audio interface unit 20. Audio interface unit 20 may have the capability to engage in audio communications sessions via other protocols, such as protocols using URI or URL identifiers.

Mixer unit 40 may be of known construction and may include one or more mixers and other components (e.g., amplifiers, filters) and may be capable of performing signal processing algorithms such as DTMF blocking, automatic gain control (AGC) and echo cancellation. In operation, mixer unit 40 typically acts to accept various audio input streams (e.g., from audio conversations), to combine such streams using known methods, and to output such streams. User/system interface unit 30 may allow a user or a controller to control and monitor the operation of teleconference system 10. For example, if teleconference system 10 is a stand-alone unit, user/system interface unit 30 may include or interface with a keyboard and monitor. Teleconference system 10 may be part of, for example, a telephone exchange, a PBX, an intra-organizational telephone system, or other equipment, and thus user/system interface unit 30 may interface with other equipment.

The processor 50 may be any conventional data processor or data processing system, such as a microprocessor, computer on a chip, PC, workstation, or specialized processor. The processor 50 may have capabilities such as DTMF processing, speech recognition capabilities, VoiceXML (VXML) interpretation and processing capabilities, and ability to transmit audio messages or text to speech messages to users. In various embodiments, user inputs may be through various methods, such as DTMF, spoken information, information processed by VXML processes, or other methods.

In alternate embodiments, the functionality of the various units in teleconference system 10 may be omitted or may be distributed or combined among/in other units. For example, a user interface capability need not be required. In embodiments of the present invention, the teleconference system 10 may be integrated with, or its functionality performed by, components of a system such as a PBX or PSTN system, or another system.

In one embodiment of the system and method of the present invention, a user account is maintained at the teleconference system 10. The user account may be in database 60 but may be maintained in other manners. Typically, the user account includes a list of participants' identifiers. Users or participants' identifiers may be, for example, telephone numbers, URLs, Uniform Resource Identifiers (URIs), IP addresses, personal identification numbers (“PINs”), voiceprints, email addresses, or other identifiers that describe a user or provide the address of a communication device. The user account typically also includes and one or more identifiers for the user. Identifiers may be associated with one or more communications devices 200. For example, a communications device 200 may be associated with a telephone number, URI, URL, etc. The identifiers associated with the same set of participants or “team ” may be of different types or formats. A teleconference group or team may be associated with a stored identifier or name, possibly a stored audio message, used to identify the group or team.

The teleconference system 10 typically is associated with one or more contact addresses or identifiers. For example, the teleconference system 10 may be associated with one or more toll free or other telephone numbers to which users may place calls. Typically, telephone calls placed to or other communications sessions initiated to teleconference telephone numbers are received and handled by audio interface unit 20; in alternate embodiments, other systems and methods may be used to accept audio communications sessions. In alternate embodiments, part or all of the communications between teleconference system 10 and conference call participants may be via other methods, such as via a network such as the Internet. For example, users and the teleconference system 10 may use IP addresses to contact and communicate with one another.

Typically, a user may use one of the communications devices 200 to place a telephone call to a teleconference telephone number. Typically, via this one telephone call, and with little or no additional operation, the teleconference system 10 initiates a teleconference on behalf of the user. The teleconference system 10 receives the telephone call and typically determines the identifier (e.g., telephone number) of the communications device 200 used to place the call or otherwise determines an identification for the calling party. The telephone number of the communications device 200 may be used as a user identification to reference the user account associated with the communications device 200. In alternate embodiments, other methods of identification may be used to associate a user with a user account; for example, the URL or URI of the communications device 200, one or a series of DTMF tones or a voice command or voice print entered at the user's communications device 200 and recognized by teleconference system 10. In further embodiments, a user may contact teleconference system in different manners, such as using an IP connection.

The user account associated with the communications device 200 typically includes a series of participant identifiers, such as telephone numbers. For example, a group of family members that a user wishes to contact as a group may be included. In one embodiment, the database 60 includes a series of entries each including a user identifier and an associated teleconference participant identifier; multiple such entries are included for each user. In another embodiment, the database 60 includes a series of entries each including a user identifier and one or more associated teleconference participant identifiers. In a typical embodiment, the identifiers are telephone numbers, but may be other types of identifiers as discussed herein. Other storage formats may be used.

Upon receipt of a user telephone call or other user initiated communications, the teleconference system 10, using known teleconference methods, determines the teleconference participant identifiers and attempts to contact the teleconference participant via the associated communications devices 200 and to join them to a teleconference. Such contact may be, for example, by making telephone calls to participant telephone numbers, contacting via URIs or URLs, or other methods. The determination may be done, for example, via a database lookup, or by other methods. All those participating in a teleconference may be referred to as “team members.” Typically, audio interface unit 20 initiates and maintains such communications sessions, although other methods may be used. Afterwards, a typical teleconference may take place, as is known in the art. During the teleconference, the user and the various teleconference participants may control the teleconference in various ways, as is known in the art.

In an alternate embodiment, a group of teleconference participants may not require a “leader” or main user. In such an embodiment, when any of a team of participants contacts the teleconference system 10, the teleconference system 10 causes a teleconference to take place among the set of teleconference participants, as discussed herein. In such an embodiment, each such team member may have a user account, but of course other arrangements are possible. One or more users may define and maintain an account, while giving conference call initiation capability to other team members.

In an exemplary embodiment, the teleconference system 10 makes one or more attempts to contact each participant in a user's list. Such attempts may have limits. For example, after three attempts which result in failures (e.g., busy signals, no pick up), the teleconference system 10 may give up with respect to a certain participant. A failure message may be audibly announced to the user and/or participants. Alternately, other retry methods may be used; for example, the teleconference system 10 may continuously retry during the course of the teleconference. If, for a participant (or a user or team leader), a list of identifiers is stored, teleconference system 10 may attempt to contact the participant at the various identifiers on the list. E.g., a user or participant may first be contacted at their office telephone number, then their cellular telephone number, then at an IP telephony address.

In an exemplary embodiment, when a user contacts the teleconference system 10, the user may be given an opportunity to alter user settings, to perform user account maintenance, and/or to alter or add to the user's teleconference list. For example, during the first few seconds of a telephone call, a user may be given an opportunity to press a certain keypad button (e.g., “#” or another key or series of keys). After pressing this key, the user may be directed to an automated menu, as is known in the art, allowing the user to use the touch-tone (DTMF) keypad to perform such account or teleconference list maintenance. Such account information may be stored in database 60 and updated/altered using known methods, but may be maintained in other manners. Other information may be associated with the user or with entries in the teleconference list, such as user or teleconference list names (e.g., text or audio versions), passwords, contact or billing information, or other information.

Various methods may be used to establish or create an account with teleconference system 10. For example, a user contacting the teleconference system 10 with an unrecognized identifier may be directed to, for example, an account initialization directory, a website, or an operator; other methods may be used. A user contacting the teleconference system 10 with an unrecognized identifier may be given an error message.

In an alternate embodiment, account maintenance functions, such as creating or maintaining a list of teleconference participants, may be effected through other methods, such as through an Internet based interface.

In one embodiment, the user, or a participant, may disconnect and reconnect at a later time during the teleconference. For example, the user may press a keypad code (e.g., “*4” or another code) to hang up. The teleconference continues after the user hangs up, but if the user dials contacts the teleconference system 10, the user is reconnected to the existing teleconference. Such functionality may be provided to the other teleconference participants. The teleconference system 10 may accept user codes which end the teleconference and disconnect all users—for example, a user pressing “9**” or another code may cause such a function to be executed. Other teleconference call maintenance functionality may be provided.

A teleconference participant, when contacted by the teleconference system 10, may be greeted by a message, and may be given the opportunity to accept or decline participation. For example, the teleconference system 10 may instruct the participant to enter one code to accept and another to decline. A teleconference participant may be greeted with the identifier or name of the teleconference group. In alternate embodiments no such greetings need be used.

Typically, the teleconference system 10 is reachable from a number of users via one address or identifier. For example, one telephone number may provide access for all users. Typically, more than one user may place and maintain a session with teleconference system 10 at the same time. In alternate embodiments, the teleconference system 10 is reachable via more than one telephone number or other address/identifier. For example, each telephone number may signal different functionality or different sets of user conference groups to the teleconference system 10. In one embodiment, where a user has more than one teleconference group associated with the user's account, the user may have access to a set of teleconference system 10 addresses, each such address assigned to a different teleconference group for that user. Typically, the same set of teleconference system 10 addresses are used for each user; and to find the proper set of participants' identifiers, the teleconference system 10 uses both the identifier of the user (or another user identification method) and the teleconference system 10 address that the user used. For example, if a certain user calls “1-800-XXX-GRP1”, the user may be connected with his or her immediate family, and if that same user calls “1-800-XXX-GRP2”, the user may be connected with his or her book club. Teleconference system 10 may have the capability to determine which of a set of addresses was used to contact teleconference system 10.

In a further embodiment, a certain user may access the teleconference system 10 via one teleconference system 10 address, and, during an initial period after connection but before teleconference initiation, may indicate which of a set of teleconference groups the user wishes to access. Such indication may be, for example, using DTMF tones, by an oral indication on the user's part (e.g., “group one”, etc), or by other methods. Teleconference system 10 may include known voice recognition technology.

In further embodiments, certain functionality described as being assigned to a system user, having an account, may be assigned to teleconference participants, and, further there may be no functional or practical difference between users and participants. Teleconference participants may connect to teleconference system 10 by, for example, making a telephone call to the teleconference system 10, possibly using the same telephone number as a registered user. Teleconference participants may then be identified using, for example, caller identification methods or other methods. Teleconference participants may then, for example, join an existing teleconference to which they have been assigned by being entered in the database 60 as a participant in a group which is now active. In case such a participant is registered to more than active group, the participant may be asked to select the conference to join. Teleconference participants may also be given other functionality, such as functionality allowing them to end or manipulate the conference call, either with respect to their own participation only or in a manner that affects the participation of other participants.

In a further embodiment, a user may pre-schedule conference calls. A user may schedule such conference calls by sending a schedule request via interfaces such as the telephone keypad, the Internet, via a VXML interface, or by interacting by voice command with an automated system or a human, or by other methods. At the pre-arranged time, all conference call participants including the user, or possibly only selected participants, are contacted, as described herein. For example, a user may, via a Web page, enter a schedule request such that the user's group of conference call participants (or, for example, one of a set of groups, or a subset of pre-registered participants) will be called and joined to a conference call at the requested time. At the requested time the teleconference system 10 initiates the conference call.

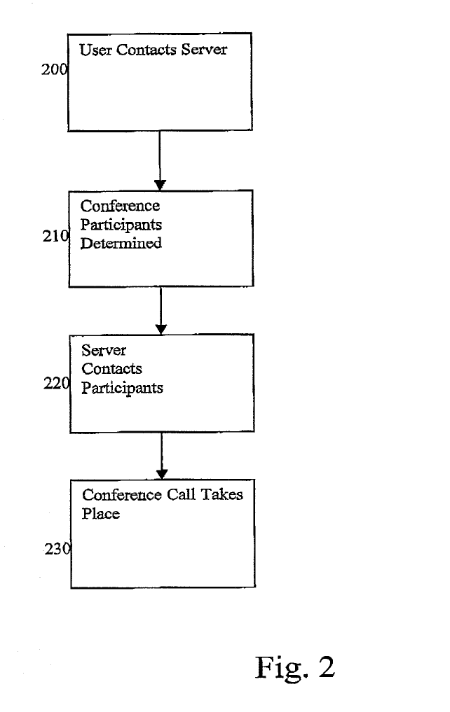

FIG. 2 is a flow chart depicting a method for conducting a conference call according to an embodiment of the present invention.

Referring to FIG. 2, in step 200, a user contacts a central server. This may be done, for example, via a telephone call with a communications device 200, but may be done via other methods, such as via an IP connection.

In step 210, a user identification is used to determine a group of conference participants. This may be done, for example, by querying a database with the identifier of the communications device 200 of the user. Alternately, the server uses both the user identifier and the number (or other connection identifier) used to contact the server as a key to a list of teams; other methods may be used.

In step 220, the central server attempts to contact the teleconference participants determined in step 210 via, for example, telephone calls.

In step 230, a conference may take place.

In alternate embodiments, other steps, or series of steps, may be used.

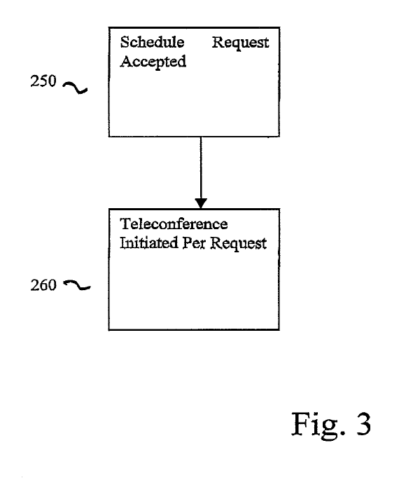

FIG. 3 is a flow chart depicting a method for initiating a conference call according to an embodiment of the present invention.

Referring to FIG. 3, in step 250, a schedule request is accepted from a user. Typically, such a schedule request may include, for example, a time and date for the conference call, and optionally the user identification of the user and a group or team identification, if multiple groups or teams are available to the user. Other types of schedule requests are possible.

In step 260, at the time denoted by the schedule request, the server initiates a teleconference, preferably according to the schedule request.

In alternate embodiments, other steps, or series of steps, may be used.

Embodiments of the present invention may include apparatuses for performing the operations herein. Such apparatuses may be specially constructed for the desired purposes, or may comprise general purpose computers selectively activated or reconfigured by a computer program stored in the computers. Such computer programs may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description herein. In addition, embodiments of the present invention are not described with reference to any particular programming language. It will be appreciated that a variety of programming languages may be used to implement the teachings of the invention as described herein.

It will be appreciated by persons skilled in the art that the present invention is not limited by what has ben particularly shown and described hereinabove. Rather the scope of the invention is defined by the claims that follow:

1. A method for facilitating a teleconference, the method comprising:
accepting a connection to a destination address;
determining a user identification of the user initiating the connection; and
attempting to initiate audio communication sessions to each of a list of conference call participants, wherein the list is associated with the user identification.

2. The method of claim 1, wherein the connection is a telephone call.

3. The method of claim 1, wherein the audio communication sessions are telephone calls.

4. The method of claim 1, wherein the user identification is a user telephone number.

5. The method of claim 1, wherein the user identification is a URL.

6. The method of claim 1, wherein the user identification is a URI.

7. The method of claim 1, wherein the user identification is an IP address.

8. The method of claim 1, comprising determining the user identification via received touch-tone keypad signals.

9. The method of claim 1 comprising adding each successfully called conference call participant to a conference call.

10. The method of claim 1, comprising:
accepting from a user a list of telephone numbers; and
associating each of the list of telephone numbers with a user identification associated with the user.

11. The method of claim 1, wherein a user identification is associated with a plurality of list of conference call participants.

12. The method of claim 11, wherein:
the destination address is one of a set of destination telephone numbers; and
which list of conference call participants is used for a conference call depends on the destination address used by the user.

13. A system for facilitating a teleconference, the system comprising:
a database means for storing a set of user records, each user record including participant records; and
a controller means for accepting a telecommunication connection from a user to a destination address, the user being associated with a user, and, in response, attempting to initiate audio communication sessions to each of the list of participants associated with the user.

14. A system for facilitating a teleconference, the system comprising:
a database including a set of user identifications, each user identification associated with a list of participants; and
a controller operative to accept a connection from a user to a destination address, the user being associated with a user identification, and, in response, to attempt to initiate audio sessions to each of the list of participants associated with the user identification.

15. The system of claim 14, wherein the system is part of a telecommunications system.

16. The system of claim 14, wherein the user identification is a user telephone number.

17. The method of claim 14, wherein the user identification is a URL.

18. The method of claim 14, wherein the user identification is a URI.

19. The method of claim 14, wherein the user identification is an IP address.

20. The system of claim 14, wherein the controller is operative to determine the user identification via received touch-tone keypad signals.

21. The system of claim 14 wherein the controller is operative to add each successfully called call participant to a conference call.

22. The system of claim 14, wherein the controller is operative to:
accept from a user a list of telephone numbers; and
associate each of the list of telephone numbers with a user identification associated with the user.

23. The system of claim 14, wherein a user identification is associated with a plurality of list of conference call participants.

24. The system of claim 14, wherein:
the destination address is one of a set of destination addresses; and
which list of conference call participants is used for a conference call depends on the destination address used by the user.

25. A method for initiating a teleconference, the method comprising:
accepting a schedule request from a user; and
at the time denoted by the schedule request:
determining a set of conference call participants associated with the user; and
attempting to join each of the set of conference call participants to a conference call.

26. The method of claim 25, wherein the user has a user identification.

27. The method of claim 25, wherein the user identification is a telephone number.

28. The method of claim 25 comprising:
accepting from a user a list of telephone numbers; and
associating each of the list of telephone numbers with a user identification associated with the user.

29. A system for initiating a teleconference, the system comprising:
a database including a set of users, each user associated with a set of conference call participants; and
a controller capable of accepting a schedule request and, at the time denoted by the schedule request, determining a set of conference call participants associated with the user; and attempting to join each of the set of conference call participants to a conference call.

30. The system of claim 29, wherein the user has a user identification

31. The system of claim 29, wherein the user identification is a telephone number.

32. The system of claim 29, wherein the controller is capable of accepting from a user a list of telephone numbers and associating each of the list of telephone numbers with a user identification associated with the user.

33. A system for initiating a teleconference, the system comprising:
a database means for storing a set of users, each user associated with a set of conference call participants; and
a controller means for accepting a schedule request and, at the time denoted by the schedule request, determining a set of conference call participants associated with the user; and attempting to join each of the set of conference call participants to a conference call.
